(19) United States
(12) Patent Application Publication
(10) Pub. No.: US 2008/0290562 A1
(43) Pub. Date: Nov. 27, 2008

(54) METHOD FOR PRODUCING PATTERNED PVC

(75) Inventor: Alan J. Gitkin, Bonita Springs, FL (US)

Correspondence Address: FELDMANGALE, P.A., ONE BISCAYNE TOWER , 30TH FLOOR , 2 SOUTH, BISCAYNE BOULEVARD, MIAMI, FL, 33131-4332, US

(73) Assignee: GULFCOAST INTERNATIONAL PRODUCTS, INC., Naples, FL (US)

(21) Appl. No.: 12/124,867

(22) Filed: May 21, 2008

Related U.S. Application Data
(60) Provisional application No. 60/939,193, filed on May 21, 2007.

(51) Int. Cl. B29C 47/36

(52) U.S. Cl. 264/328.14

(57) ABSTRACT

The instant invention discloses and claims a method for producing PVC exhibiting a background color and colored accent veins comprising the steps of selecting and mixing colors for a duration sufficient to produce a heterogeneous mixture of colors. The method may be used to produce faux wood, faux marble or other treatments where a mixed color scheme is desirable.

### CROSS-REFERENCE TO RELATED APPLICATION

The present application claims priority benefit under 35 U.S.C. §119(e) of U.S. Provisional Patent Application Ser. No. 60/939,193 filed May 21, 2007. The disclosure this application is incorporated herein by reference.

### FIELD OF INVENTION

The instant invention lies in the field of preparing patterned PVC useful in manufacturing items exhibiting a decorative “natural” appearance such as “faux” wood or “faux” marble.

### BACKGROUND OF INVENTION

Historically, numerous items broadly described as home furnishings have been constructed using natural wood. Such items include Venetian blind systems, doors, shutters, window frames and many others. There are significant drawbacks to using wood, however. Natural wood is expensive, and requires relatively skilled labor to work with. Furthermore, wood is frangible leading to significant wastage during the fabrication of such items. From the perspective of consumers, there are other disadvantages associated with the use of natural wood. Wood is difficult to clean, expensive, prone to chipping and warping.

Notwithstanding the difficulties associated with wood, there nevertheless remains a significant and active market for wood materials because consumers like the appearance of wood, in particular the random mixture of shades and colors that form the natural appearance wood grain.

In recent years, manufacturers have begun producing such home furnishings from different materials capable of extrusion including plastics such as polyvinyl chloride (PVC) or similar. These materials are relatively inexpensive to fabricate, easy to manipulate during the manufacturing process, offer ease of maintenance and are capable of taking on different decorative appearances. They can be colored, textured, patterned or printed with patterns and from an aesthetic perspective present a substantial and solid appearance.

Often, for example, the furnishings are manufactured and processed to resemble wood with “fauxwood” blinds, for example, considered to be a staple product in the home improvement industry. Fauxwood is an industry catch phrase for vinyl products that are extruded in a typically hollow format and then injected with a blowing agent. The result is a low cost material that can take on the characteristics of wood without some of wood's disadvantages which include cost, yellowing, warping, chipping and similar problems.

One of the chief difficulties that exist with the production of fauxwood products is the difficulty of creating the natural appearance of wood. While it is relatively simple to texture fauxwood and thereby create the texture of natural wood, the texturing does nothing to produce the look of natural wood grain caused by the mixture of colors and shades that appear.

There have been numerous prior art attempts to produce a fauxwood that not only has the texture of wood but also exhibits the realistic mixes of colors. Such prior art efforts have included the silk-screening or other printing of patterns on extruded PVC material, thermal imaging, film hot stamping, labeling, and the incorporation of particulate wood into the PVC during its processing. These techniques, however, are complex, cumbersome and in many cases fail to produce the random appearance of natural wood as the “grain” is repeated on the fauxwood output. The failure to achieve the random patterns that occur in nature is a significant detriment from an aesthetic and marketing perspective.

Accordingly, there is a need for a relatively simple method of producing a random, natural wood like appearance having random patterns and color mixtures. Furthermore, it should be recognized that this invention is not limited to generating PVC to replicate the patterns of wood. Any time a background color is desired that incorporate colored accent veins, this technique may be used.

### PRESENT INVENTION

The present invention discloses a novel process for generating extruded PVC having the appearance of natural wood by selecting color pellets and controlling the duration of the color mixing process such that the color materials are never allowed to completely and thoroughly mix. Thus while a background tone is generated, the PVC exhibits in addition to the background color discrete veins of color on the surface and throughout. While the term colored pellets is used herein, this term should not be construed to exclude white or black coloring pellets as such may be used to generate accent and background colors consistent with this invention. By relying on widely used equipment and well known processes for producing PVC, the present invention is readily useable in or adapted to the standard method of producing PVC for extrusion.

The practice of producing colored PVC for extrusion is well known in the industry. The traditional method for generating colored PVC is to use readily available colored thermoplastic pellets in a set mixture to extrude a desired color. The coloring pellets are added to or with the base material of PVC and impart color thereto. As a simple example, if a green PVC is desired, a mixture in a set ratio of blue and yellow color pellets me be used to impart color to the base PVC material. Alternatively green pellets are available and could be darkened or lightened by the admixture of other colored pellets. The process of selecting coloring pellets to generate different shades of PVC is well known in the art.

Upon heating and melting of the pellets, the molten materials are mixed in a “screw” processor and will, when sufficiently mixed, as in the above example, produce a green PVC that can be extruded into various desired shapes for a wide variety of applications.

Such a process, however, completely mixes the PVC pellets and generates a uniform colored PVC. While that is desirable for certain applications where a single, uniform color is desired, it does not produce the random color variations and streaked patterns that appear in natural wood.

The present invention introduces a novel variation to the technique by regulating the duration of the mix. This process begins by selecting particular accent colors for mixing with the base materials to produce a simulation of the colors occurring in the desired natural woods. Given the wide range of colors associated with the numerous types of wood available for these uses, the choice of colors is unlimited and depends on the colors which the fabricator is attempting to simulate.

When the desired color is formulated by selecting a mix of color pellets, the pellets are introduced into the PVC extruding assembly. In common industrial application, extruded PVC production assemblies form three generally distinct zones. There is a feed or entry zone, a heating zone and an extrusion zone. In a typical arrangement where colored PVC is being generated, the pellets are introduced at the entry zone via a hopper or other chamber. From the hopper, the variously colored pellets are introduced into the heating zone into a heating chamber where the pellets are allowed to soften and melt.

The material is then introduced into a “screw” processor which begins the process of mixing the colored thermoplastic pellets. When uniformly colored PVC is being produced, the “screw” process continues until the colors are completely and homogenously mixed. The actual amount of time necessary for a complete mixing varies significantly depending on the size of the batches being run through the “screw” processor, the size of the screw, the speed at which the screw turns, the particular characteristics of the color pellets used and the heat of the heating chamber among other factors.

In the process disclosed herein, however, the molten colored plastic is not allowed to fully and homogenously mix. Thus the operator ceases the “screw” mixing prior to the time when the colors generated by the color pellets have blended into a uniform color but after the pellets have melted. In the process disclosed herein, the heterogeneous mixture is then transferred from the “screw” processor to a paddle chamber in which a mixing paddle is present. The mixing paddle further processes the mixture without allowing the color to completely mix by using a speed and intensity such that heterogeneously colored extended bands are formed. Depending on the desired effect, the paddle mixer may or may not be applied.

By carefully controlling the duration of the mixing, the PVC is allowed to color while preserving discrete and heterogeneous bands of color. The resulting mixture is molten PVC that has a background color but also maintains accent veins of different colors interspersed throughout. This effect is brought about by halting the mixing process before the molten colored pellets are allowed to completely and homogenously mix.

Once the paddle processing is complete, the PVC enters the extrusion zone and is extruded into dies or other devices which allow it to be formed into any required shape. From there, the extruded PVC enters a cold bath and processing is complete. The resulting PVC exhibits a natural appearance with background colors accented with veins of other colors appearing on the surface and throughout the PVC.

It should be appreciated, that a wide variety of woods may be simulated by varying the color selection and mixing durations. It should also be readily appreciated that other decorative appearances and simulated natural materials may be prepared using this process. Thus depending on the color of the pellets chosen and the mix duration, simulacra of marble and other stones or any material exhibiting a veinous appearance may be formed.

### BRIEF DESCRIPTION OF THE DRAWING

FIG. 1 is a graphical presentation of the process whereby patterned PVC may be produced by the method according to the present invention.

### DETAILED DESCRIPTION OF THE EMBODIMENTS

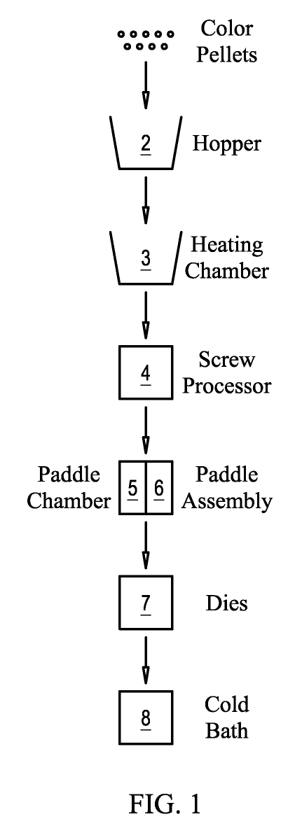

FIG. 1 is a depiction of a process according to the present invention whereby a simulated natural wood extruded PVC may be produced. The same process may be used to produce other patterned effects where, similar to natural wood, a background color is desired with accent streaks of color extending throughout. First, the operator selects different color pellets 1 according to the desired ending background and accent colors. If the operator, for example, wishes to replicate a brown wood with yellowish grain, appropriate color pellets from the brown spectrum may be chosen for the background color with accent pellets chosen from a yellow spectrum. When mixed according to this process, the extruded PVC will exhibit the desired background color and color veins when mixed. If a reddish wood is desired, different colored pellets are chosen. It should be readily appreciated that this same process may be used to generate any color scheme whereby a background color is accented with veins of a different color or colors from the background. The selected colored pellets are then added to standard base material typically used in PVC extrusion systems. Such materials may include any typically used base materials and additives that are used in fabricating extruded PVC materials.

Once the color pellets 1 are selected they are introduced into the extrusion assembly and to the base PVC materials via a hopper 2 or other chamber. From the hopper, the pellets are introduced into a heating chamber 3. Alternatively, the pellets may be introduced directly into a heating chamber 3.

In the heating chamber 3 the pellets and PVC base are allowed to melt and form a molten mixture of colored pellets and base. When the colored pellets have sufficiently melted, the molten mixture is transferred into a “screw” processor 4.

The “screw” processor 4 mixes the molten mixture composed of the base materials in conjunction with the colored pellets. The “screw” processor 4 mixes the materials until such a time that the now-molten color pellets are allowed to mix but not completely. The duration of this period varies depending on numerous factors including the size and speed of the “screw” assembly, the size of the batch, the characteristics of the colored pellets, the heat of the mixture and other similar factors. At this stage of the process, however, the mixture exhibits a heterogeneous mixture of background color with discrete areas of accent colors.

From the “screw” processor 4, the molten mixture is introduced into a paddle chamber 5. In the paddle chamber 5, a paddle assembly 6 further mixes the molten mixture without allowing it to form a homogenous color. The paddle assembly mixes the molten mixture at a speed and pattern to allow the formation of extended veins of color without completely mixing the colors generated by the pellets into a uniform homogenous color. The appearance of the veins may be regulated by use of different sized and shaped paddles as well as by applying the paddles at different speeds and forces. It should be appreciated that depending on the configuration of elements in the extrusion assembly the paddle mixer need not form a specific chamber. A mixing paddle may, for example, be introduced into the “screw” processor and the paddle mixing may occur there. Alternatively the paddle assembly may be omitted with required mixing being carried out by the “screw” assembly.

When the mixture has been subjected to the paddle assembly for a sufficient time and duration to generate the desired mixture of background color and accent veins, the molten PVC is extruded into dies or molds 7 to form the molten PVC mixture into any desired shape and form. The formed PVC may then be transferred to a cold bath 8 where it is allowed to set.

The resulting PVC exhibits a background color with veins of accent color on the surface and throughout that may simulate a wide variety of natural woods or other materials or treatments where a background color exhibiting different colored accent veins is present.

I claim:

1. A method for producing patterned PVC comprising the steps of:
selecting thermoplastic pellets from a plurality of colored pellets;
introducing PVC base material into a chamber;
introducing the selected thermoplastic pellets into the chamber;
heating the PVC base material and the selected thermoplastic pellets until the PVC base material and selected thermoplastic pellets melt;
mixing the melted selected thermoplastic pellets and base material sufficiently to produce a heterogeneously colored molten mixture comprising a discrete background color and discrete colored accent veins;
extruding the heterogeneously colored molten mixture; and
allowing the heterogeneously colored molten mixture to set.

2. The method of claim 1 wherein the molten mixture is extruded into dies and then allowed to set.

3. The method of claim 2 wherein the melted PVC base material and selected thermoplastic pellets are mixed by a screw processor.

4. The method of claim 3 wherein the melted PVC base material and selected thermoplastic pellets are further mixed by a paddle mixer.

5. The method of claim 2 wherein said plurality of selected thermoplastic pellets comprise one or more accent colors.
